(19) United States
(12) Patent Application Publication
(10) Pub. No.: US 2009/0227297 A1
(43) Pub. Date: Sep. 10, 2009

(54) MOBILE TELEPHONE DEVICE

(75) Inventors: Fumihiro Muramatsu, Shizuoka (JP); Kiyoshi Nakanishi, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Kadoma-shi, Osaka (JP)

(21) Appl. No.: 11/573,403

(22) PCT Filed: Aug. 1, 2005
(86) PCT No.: PCT/JP05/14050

§ 371 Date: Feb. 8, 2007

(30) Foreign Application Priority Data
Aug. 12, 2004 (JP) 2004-235208

(51) Int. Cl. H04M 1/00

(52) U.S. Cl. 455/567

(57) ABSTRACT

It is intended to provide a cellular telephone apparatus which employs a single sound-producing body as both of a receiver for reproducing a speech sound and a speaker for reproducing a ringer tone and which can secure a necessary reproduction frequency characteristic for each of the reproduction of a speech sound and the reproduction of a ringer tone. During reproduction of a ringer tone, the characteristic of a lowpass filter 130b is chosen as the frequency characteristic of a digital lowpass filter 130, a speaker 135 is driven by rendering a preamplifier 133b and a push-pull circuit 133d of a speaker amplifier 133 in an active state and setting the output form (circuit configuration) of the speaker amplifier 133 to BTL output, and the signal pass-band is set to a pass-band of 100 Hz to 20 kHz. During reproduction of a speech sound, the characteristic of a lowpass filter 130a is chosen as the frequency characteristic of the digital lowpass filter 130, the speaker 135 is driven by rendering the preamplifier 133b and the push-pull circuit 133d of the speaker amplifier 133 in a halt state and setting the output form (circuit configuration) of the speaker amplifier 133 to single output, and the signal pass-band is set to a pass-band of 300 Hz to 3 kHz.

### TECHNICAL FIELD

The present invention relates to a cellular telephone apparatus. In particular, the invention relates to a cellular telephone apparatus in which a single sound-producing body serves as both of a receiver for reproducing a speech sound and a speaker for reproducing a ringer tone.

### BACKGROUND ART

Conventionally, in cellular telephone apparatuses, it is a common practice to reproduce a ringer tone with a speaker at the time of call arrival and to reproduce a speech sound with a receiver during a call.

FIG. 7 is a block diagram showing the circuit configuration of a conventional cellular telephone apparatus. In this cellular telephone apparatus 700, reception signals received by an antenna 701 are supplied via a duplexer 702 to a receiving circuit 703, where a desired reception channel signal is selected. The selected signal is sent to a demodulator 704.

The demodulator 704 performs digital demodulation processing, error correction processing, etc. If the reception signal is a ringing signal, a microprocessor 710 activates a speaker amplifier power source 740, sets a prescribed ringer tone in a ringer tone source 723, and causes it to generate a ringer tone signal. The ringer tone signal is supplied via a digital lowpass filter to a D/A converter 725, where it is converted into an analog signal. Its volume is then set to a prescribed value by a volume setting device 726. A speaker amplifier 727 current-amplifies the volume-set ringer tone signal and drives a speaker 729 via a high-pass filter 728.

On the other hand, if reception data demodulated by the demodulator is a speech signal, the microprocessor 710 activates a receiver amplifier power source 741. The demodulator 704 sends the reception signal to a decoder 721, where it is subjected to prescribed decoding processing and thereby converted into speech data. The speech data is supplied via a digital lowpass filter 730 to a D/A converter 731, where it is converted into an analog signal. Its volume is then set to a prescribed value by a volume setting device 732. A receiver amplifier 733 current-amplifies the volume-set speech signal and drives a receiver 735 via a high-pass filter 734.

A microphone 750 converts a voice into a transmission speech signal, which is then amplified to a prescribed signal level by a microphone amplifier 751 and converted into a digital signal by an A/D converter 752. The transmission speech signal as converted into the digital signal by the A/D converter 752 is encoded by an encoder 722, subjected to digital modulation in a modulator 705, processed so as to be carried by a signal having a prescribed channel frequency by a transmitting circuit 706, and transmitted from the antenna 701 via the duplexer 702.

In general, each of the speaker 729 and the receiver 735 is a dynamic speaker which is composed of a fixed magnet and a voice coil in which a coil is attached to a vibration plate or a ceramic speaker using a piezoelectric device.

The functions of the ringer tone source 723 as incorporated in recent cellular telephone apparatuses are equivalent to those of a sound source incorporated in karaoke equipment, such as 40 chords. And the ringer tone reproduction frequency band of the ringer tone source 723 is as wide as 100 Hz to tens of kilohertz. On the other hand, the speech sound reproduction band is standardized so as to fall approximately within a range of hundreds of hertz to several kilohertz (depends on the communication scheme) and hence is narrower than the ringer tone reproduction band.

Speakers for ringer tone reproduction need to produce a large-volume tone. Therefore, for example, a dynamic speaker having equivalent impedance of 8Ω is employed. Where a ceramic speaker is used, a necessary volume is secured by applying a voltage of about 9 V to it.

On the other hand, speakers for speech sound reproduction are not required to produce a sound of as large a volume as speakers for ringer tone reproduction are required. Therefore, a dynamic speaker having equivalent impedance of 32Ω is employed. Where a ceramic speaker is used for speech sound reproduction, a voltage of about 9 V need not be applied to it unlike in the case where it is used for ringer tone reproduction.

The speaker amplifier 727 for driving the speaker 729 and the receiver amplifier 733 for driving the receiver 735 are amplifiers having different characteristics because of the above-described differences in reproduction bandwidth and the speaker (load) to drive. The speaker amplifier 727 is an amplifier which is large in circuit current because it is required to have a wider bandwidth and a higher drive-current-providing ability than the receiver amplifier 733, for the following reason. In general, to reduce the cross-over distortion, class AB amplifiers are used as speaker amplifiers. Although amplifiers for driving a receiver having equivalent impedance of 32Ω and amplifiers for driving a speaker having equivalent impedance of 8Ω both perform class AB operation, the bias voltage of the output-stage transistor of the former is set small and that of the latter is set large to accord with the difference in load current. The circuit current consumed in the amplifier itself is optimized in this manner.

Furthermore, the frequency characteristics of dynamic speakers and ceramic speakers (loads) have great influence on the drive circuit. Dynamic speakers are inductive loads and ceramic speakers are capacitive loads. Therefore, ceramic speakers decrease in impedance and become heavier loads as the drive frequency increases. Therefore, to use a ceramic speaker for ringer tone reproduction, it is necessary to assume a load operating at 20 kHz and to set a bias voltage for class AB amplification, which results in a tendency that the circuit current consumed by the amplifier itself increases.

In the circuit configuration of the conventional cellular telephone apparatus, the receiver amplifier power source 741 is turned off during reproduction of a ringer tone and the speaker amplifier power source 740 is turned off during reproduction of a speech sound, which enables operation with an optimum current consumption in each of the reproduction of a ringer tone and the reproduction of a speech sound.

Cellular telephone apparatuses are known in which for their miniaturization a common speaker and amplifier are used for both of the reproduction of a ringer tone and the reproduction of a speech sound (refer to Patent document 1, for example).

In cellular telephone apparatuses of this type, when the volume of a ringer tone indicated by an output signal of a ringer tone output circuit exceeds a reference volume continuously, a ringer tone volume control circuit controls the increase rate of the volume exceeding the reference volume. This makes it possible to use a single speaker as both of a speaker for reproduction of a ringer tone and a speaker for reproduction of a speech sound and to thereby realize miniaturization of a cellular telephone apparatus.

Patent document 1: JP-A-2002-185571

### DISCLOSURE OF THE INVENTION

### Problems to Be Solved by the Invention

However, in the above conventional cellular telephone apparatuses, the common speaker is merely used as both of the speaker for reproduction of a speech sound and the speaker for reproduction of a ringer tone and no consideration is given to the difference between the reproduction frequency band for the reproduction of a speech sound and that for the reproduction of a ringer tone. Therefore, it is impossible to secure a necessary reproduction frequency band for the reproduction of a ringer tone while satisfying the standard of the reproduction frequency band for the reproduction of a speech sound. Furthermore, the current consumption during reproduction of a speech sound is made higher than in the other conventional case where a speech sound and a ringer tone are reproduced by independent sets of a drive circuit and a sound-producing body.

In the above cellular telephone apparatuses, the common sound-producing body is required to be used for both of the purpose of producing a large-volume ringer tone and the purpose of producing a small-volume speech sound. Therefore, a dynamic speaker having equivalent impedance of 8Ω is used as the common speaker. If a ceramic speaker is used as the common speaker, a voltage of about 9 V needs to be applied to it, which necessitates a booster circuit. As a result, the drive circuit of the cellular telephone apparatus disclosed in Patent document 1 consumes much more power during a call than the other conventional circuit configuration.

The present invention has been made in view of the above circumstances in the art, and an object of the invention is therefore to provide a cellular telephone apparatus which employs a single sound-producing body as both of a receiver for reproducing a speech sound and a speaker for reproducing a ringer tone and which can secure a necessary reproduction frequency characteristic for each of the reproduction of a speech sound and the reproduction of a ringer tone.

### Means for Solving the Problems

The invention provides a cellular telephone apparatus in which a single sound-producing body is used as both of a sound-producing body for reproducing a speech sound and a sound-producing body for reproducing a ringer tone and a drive circuit for driving the sound-producing body is a single drive circuit, comprising a drive circuit switching unit which switches a drive form of the drive circuit, and a control unit which controls the switching of the drive form of the drive circuit.

This configuration enables switching between different drive forms and hence makes it possible to use a single sound-producing body as a receiver for reproducing a speech sound and a speaker for reproducing a ringer tone.

The drive form that is switched by the drive circuit switching unit includes BTL drive output and single drive output.

This configuration enables switching between the BTL drive output and the single drive output and hence makes it possible to drive the drive circuit properly in, for example, both of a case that a large volume is necessary and a case that it is not necessary.

The control unit causes switching of the drive form of the drive circuit so that BTL drive output is selected as the drive form of the drive circuit during reproduction of a ringer tone and single drive output is selected as the drive form of the drive circuit during reproduction of a speech sound.

With this configuration, during reproduction of a ringer tone, a large-volume tone can be produced by BTL-output driving. During reproduction of a speech sound, whereas a sufficiently large volume to reproduce a speech sound can be secured by single-output driving, the current consumed by the drive circuit can be reduced and the usable time for calls of the cellular telephone apparatus can thereby be elongated by suspending one of the BTL outputs of the drive circuit.

The invention also provides a cellular telephone apparatus in which a single sound-producing body is used as both of a sound-producing body for reproducing a speech sound and a sound-producing body for reproducing a ringer tone and a drive circuit for driving the sound-producing body is a single drive circuit, comprising a power circuit output state switching unit which switches an output state of a power circuit for the drive circuit for driving the sound-producing body between boosted voltage output and non-boosted voltage output, the sound-producing body using a piezoelectric device, and a control unit which controls the switching of the output state of the power circuit for the drive circuit for driving the sound-producing body.

In this configuration, a booster circuit that is provided in the power circuit for the drive circuit is activated when a large volume is necessary and switching is made to a non-boosting circuit when a large volume is not necessary. This configuration thus makes it possible to reduce the current consumed by the power circuit for the drive circuit and to thereby elongate the usable time for calls of the cellular telephone apparatus.

The control unit performs a control so that the power circuit output state is made the boosted voltage output during reproduction of a ringer tone and it is made the non-boosted voltage output during reproduction of a speech sound.

With this configuration, a booster circuit that is provided in the power circuit for the drive circuit is activated during reproduction of a ringer tone in which a large volume is required, whereby a voltage that is a little more than 10 V can be applied to the drive circuit. During reproduction of a speech sound, the booster circuit which is provided in the power circuit for the drive circuit is disabled and a voltage that is high enough to reproduce a speech sound and is provided in the power circuit is output. As a result, during reproduction of a speech sound, the current consumed in the power circuit for the drive circuit can be reduced and hence the usable time for calls of the cellular telephone apparatus can be elongated.

The cellular telephone apparatus according to the invention further comprises a bias voltage switching unit which switches a bias voltage of an output-stage transistor of the drive circuit for driving the sound-producing body depending on which of a ringer tone and a speech sound is to be reproduced.

In this configuration, the bias voltage of the output-stage transistor of the drive circuit is switched depending on which of a ringer tone and a speech sound is to be reproduced. Therefore, during reproduction of a ringer tone, the output-stage transistor of the drive circuit can be given so high a voltage that cross-over distortion does not occur even when the drive frequency is about 20 kHz. High sound quality can thus be secured. During reproduction of a speech sound, the bias voltage which is applied to the output-stage transistor of the drive circuit is reduced to such a degree that cross-over distortion does not occur at several kilohertz, whereby the current consumed by the drive circuit itself can be reduced and hence the usable time for calls of the cellular telephone apparatus can be elongated.

The control unit switches a signal pass-band characteristic of the drive circuit for driving the sound-producing body or a preprocessing circuit of the drive circuit depending on which of a ringer tone and a speech sound is to be reproduced.

With this configuration, the high-frequency signal passage characteristic can be switched depending on which of a ringer tone and a speech sound is to be reproduced. As a result, a passage characteristic having an upper limit of several kilohertz can be secured during reproduction of a speech sound and a passage characteristic having an upper limit of a little more than 10 kHz can be set during reproduction of a ringer tone. Therefore, a necessary reproduction frequency characteristic can be satisfied for each of the reproduction of a speech sound and the reproduction of a ringer tone though the common drive circuit and sound-producing body are employed.

The control unit switches a signal pass-band characteristic of a post-processing circuit of the drive circuit for driving the sound-producing body depending on which of a ringer tone and a speech sound is to be reproduced.

With this configuration, the low-frequency signal passage characteristic can be switched depending on which of a ringer tone and a speech sound is to be reproduced. As a result, a passage characteristic having a lower limit of hundreds of hertz can be secured during reproduction of a speech sound and a passage characteristic having a lower limit of about 100 kHz can be set during reproduction of a ringer tone. Therefore, a necessary reproduction frequency characteristic can be satisfied for each of the reproduction of a speech sound and the reproduction of a ringer tone though the common drive circuit and sound-producing body are employed.

### ADVANTAGES OF THE INVENTION

The invention can provide a cellular telephone apparatus which employs a single sound-producing body as both of a receiver for reproducing a speech sound and a speaker for reproducing a ringer tone and which can secure a necessary reproduction frequency characteristic for each of the reproduction of a speech sound and the reproduction of a ringer tone.

### BRIEF DESCRIPTION OF THE DRAWINGS

FIG. 1 is a block diagram of a cellular telephone apparatus according to a first embodiment of the invention.

FIG. 2 shows detailed circuit configurations of a speaker amplifier and a highpass filter circuit of the cellular telephone apparatus according to the first embodiment of the invention.

FIG. 3 is a flowchart for description of the operation of the cellular telephone apparatus according to the first embodiment of the invention.

FIG. 4 is a block diagram of a cellular telephone apparatus according to a second embodiment of the invention.

FIG. 5 shows detailed circuit configurations of a speaker amplifier, a lowpass filter circuit, and a booster circuit/non-boosting circuit of the cellular telephone apparatus according to the second embodiment of the invention.

FIG. 6 is a flowchart for description of the operation of the cellular telephone apparatus according to the second embodiment of the invention.

FIG. 7 is a block diagram showing the configuration of a conventional cellular telephone apparatus.

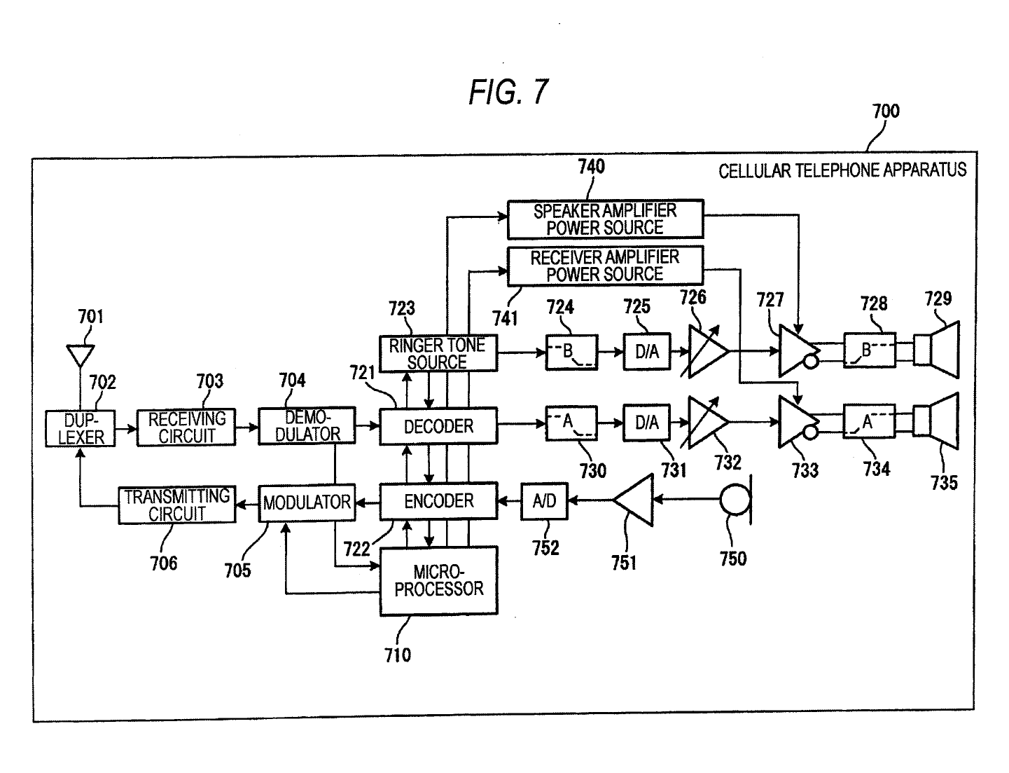

### DESCRIPTION OF SYMBOLS

100, 400: Cellular telephone apparatus
101: Antenna
102: Duplexer
103: Receiving circuit
104: Demodulator
105: Modulator
106: Transmitting circuit
110, 410: Microprocessor
121: Decoder
122: Encoder
123: Ringer tone source
130: Digital lowpass filter
131: D/A converter
132: Volume setting device
133, 433: Speaker amplifier
134: Highpass filter
135, 435: Speaker
140: Power circuit
150: Microphone
151: Microphone amplifier
152: A/D converter
430: Digital highpass filter
434: Lowpass filter
440: Booster circuit/non-boosting circuit

### BEST MODE FOR CARRYING OUT THE INVENTION

Cellular telephone apparatuses according to embodiments of the present invention will be hereinafter described with reference to the drawings.

### First Embodiment

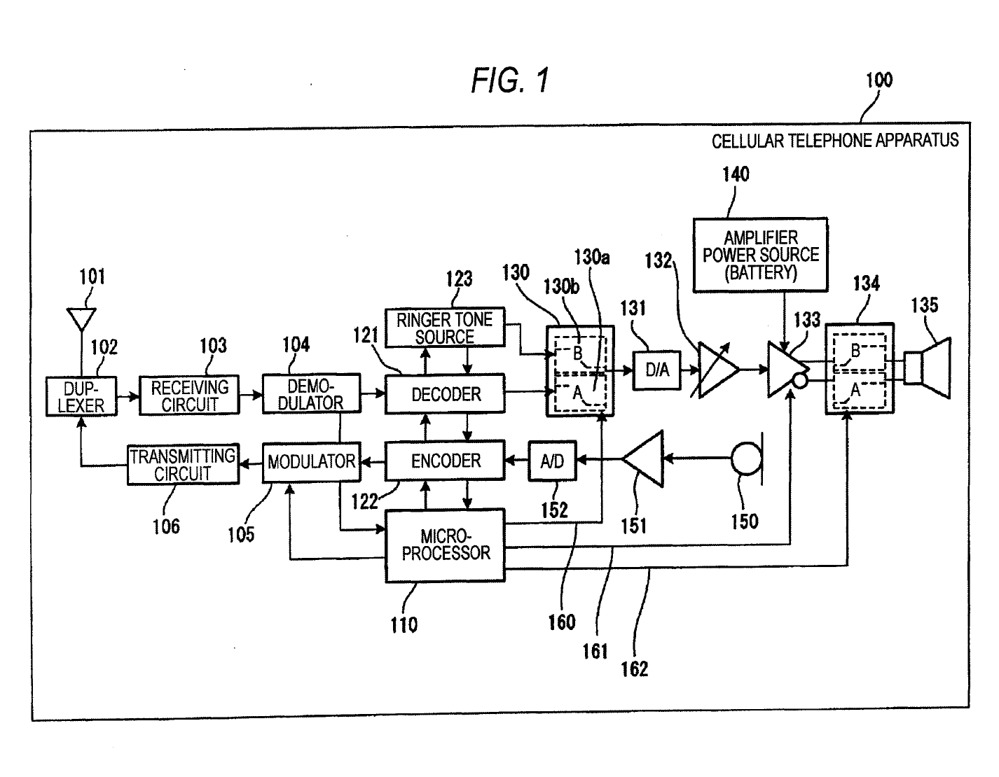

FIG. 1 is a block diagram of a cellular telephone apparatus according to a first embodiment of the invention.

As shown in FIG. 1, the cellular telephone apparatus 100 is equipped with an antenna 101 which converts reception radio waves into reception electric signals (hereinafter referred to as “reception signals”) and converts a transmission electric signal (Thereinafter referred to as “transmission signal”) into transmission radio waves, a duplexer 102 which supplies, to a receiving circuit 103, the reception signals coming from the antenna 101 and supplies, to the antenna 101, the transmission signal coming from a transmitting circuit 106, the receiving circuit 103 which amplifies the reception signals and selects a desired frequency channel, a demodulator 104 which demodulates the reception signal of the frequency channel selected by the receiving circuit 103 into a digital signal and converts the digital signal into reception speech data, reception communication data, and reception control information data, a modulator 105 which modulates and converts transmission communication data, transmission control information data, and transmission speech data into a transmission signal, a transmitting circuit 106 which superimposes the transmission signal on a carrier wave having a desired frequency channel and amplifies a resulting transmission signal, and a microprocessor 110 which controls the individual sections of the cellular telephone apparatus 100.

The cellular telephone apparatus 100 according to this embodiment is also equipped with a decoder 121 which decodes and converts the reception speech data into a reception speech signal, an encoder 122 which encodes and converts a transmission speech signal into the transmission speech data, and a ringer tone source 123 which generates and outputs a ringer tone or melody according to an instruction from the microprocessor 110.

The cellular telephone apparatus 100 according to this embodiment is further equipped with a digital lowpass filter 130 which performs high-frequency bandwidth limitation processing on the ringer tone signal coming from the ringer tone source 123 or the reception speech signal coming from the decoder 121, a D/A converter 131 which converts the ringer tone signal or the reception speech signal into an analog signal, a volume setting device 132 which sets the volume of the ringer tone signal or the reception speech signal to a prescribed value, a speaker amplifier 133 which amplifies the ringer tone signal or the reception speech signal and drives a speaker 135, a highpass filter circuit 134 which performs low-frequency bandwidth limitation processing on the ringer tone signal or the reception speech signal that is output from the speaker amplifier 133, the speaker 135 which reproduces a ringer tone or a reception speech sound, a power circuit 140 for the speaker amplifier 133, a microphone 150 which converts a voice to be transmitted into an electric signal, a microphone amplifier 151 which amplifies the transmission speech signal coming from the microphone 150, and an A/D converter 152 which converts the resulting transmission speech signal into a digital signal.

Although not shown in the figure, the cellular telephone apparatus 100 also has a memory in which control programs, ringer melody data, etc. are stored, key switches to be used for manipulating the cellular telephone apparatus, and a display unit.

Next, main sections of the cellular telephone apparatus 100 will be described. The digital lowpass filter 130, which performs high-frequency bandwidth limitation processing on a ringer tone signal coming from the ringer tone source 123 or a reception speech coming from the decoder 121, is composed of two digital lowpass filters 130a and 130b having different frequency passage characteristics. The circuit configuration is such that one of the two digital lowpass filters 130a and 130b having the different frequency passage characteristics is chosen in accordance with a selection signal 160 supplied from the microprocessor 110.

For example, of the two digital lowpass filters 130a and 130b having the different frequency passage characteristics, the one digital lowpass filter 130a is a lowpass filter whose cutoff frequency is 3 kHz and the other digital lowpass filter 130b is a lowpass filter whose cutoff frequency is 20 kHz.

The speaker amplifier 133, which amplifies a ringer tone signal or a reception speech signal and drives the speaker 135, is a BTL (balanced transformerless)—output, class AB amplifier. The circuit configuration is such that one of the BTL outputs is disabled in accordance with a selection signal 161 supplied from the microprocessor 110.

The highpass filter circuit 134, which performs low-frequency bandwidth limitation processing on a ringer tone signal or a reception speech signal that is output from the speaker amplifier 133, is composed of two highpass filters 134a and 134b having different frequency passage characteristics. The circuit configuration is such that one of the two highpass filters 134a and 134b having the different frequency passage characteristics is chosen in accordance with a selection signal 162 supplied from the microprocessor 110. For example, of the two digital highpass filters 134a and 134b having the different frequency passage characteristics, the one highpass filter 134a is a highpass filter whose cutoff frequency is 300 Hz and the other highpass filter 134b is a highpass filter whose cutoff frequency is 100 Hz. Furthermore, the circuit configuration is such that one of the input terminals of the speaker 135 is terminated to the ground when the highpass filter 134a having the cutoff frequency of 300 Hz is chosen.

In this embodiment, the speaker 135, which reproduces a ringer tone or a reception speech sound, is a dynamic speaker.

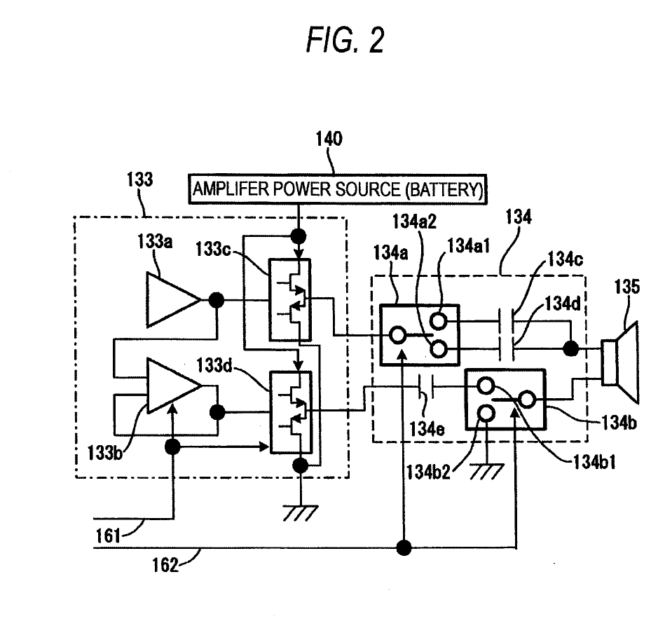

FIG. 2 shows detailed circuit configurations of the speaker amplifier 133 and the highpass filter circuit 134.

As shown in FIG. 2, the speaker amplifier 133 has a preamplifier 133a, a preamplifier 133b which phase-inverts an output of the preamplifier 133a, a push-pull circuit 133c which current-amplifies the output of the preamplifier 133a and performs class AB operation, and a push-pull circuit 133d which current-amplifies an output of the preamplifier 133b and performs class AB operation.

The circuit operation of the preamplifier 133b is stopped by a selection signal 161. Furthermore, the output transistors of the push-pull circuit 133d are turned off by the selection signal 161. In a state that the operation of the preamplifier 133b and the push-pull circuit 133d is suspended by the selection signal 161, almost no circuit current flows through the preamplifier 133b and the push-pull circuit 133d.

The highpass filter circuit 134 has analog switches 134a and 134b and capacitors 134c, 134d, and 134e which form a highpass filter when combined with the impedance of the speaker 135.

Switching between the contacts of each of the analog switches 134a and 134b can be made in accordance with a selection signal 162. The constants of the capacitors 134c and 134e are set so that the cutoff frequency of the highpass filter becomes about 100 Hz in a state that the analog switch 134a is switched to a contact 134a1 and the analog switch 134b is switched to a contact 134b1.

On the other hand, in a state that the analog switch 134a is switched to a contact 134a2 and the analog switch 134b is switched to a contact 134b2, one of the input terminals of the speaker 135 is terminated to the ground and a single drive form is thereby established. The constant of the capacitor 134d is set so that the cutoff frequency of the highpass filter becomes about 300 Hz.

Such things as voltage drops across the analog switches 134a and 134b are negligible as long as they have small on-resistance values.

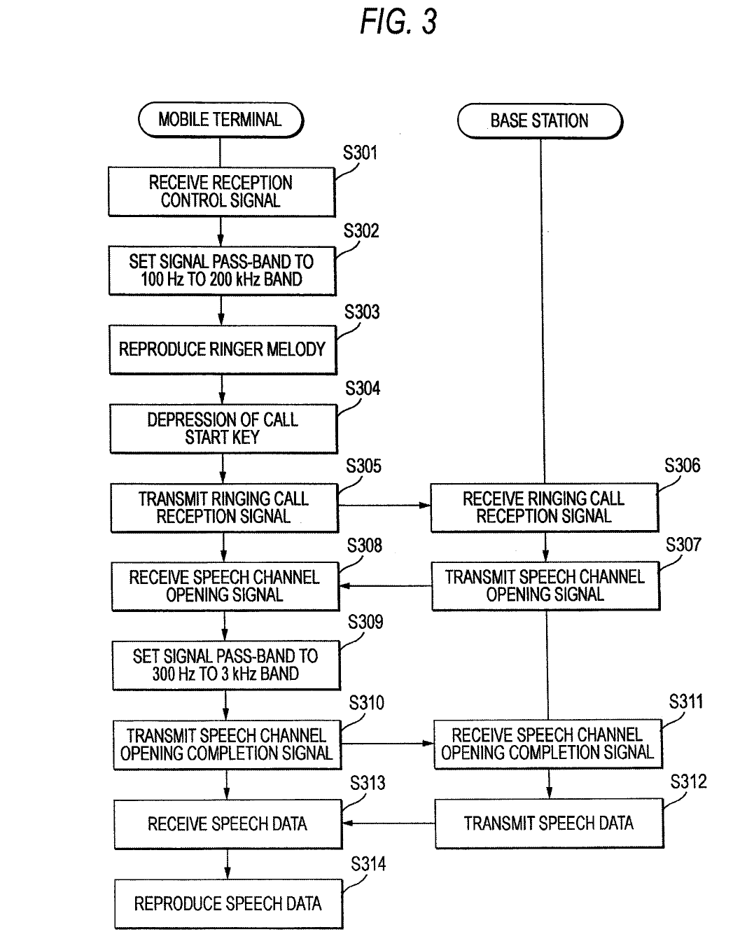

The operation of the above-configured cellular telephone apparatus will be described below with reference to FIG. 3. First, the microprocessor 110 receives reception control information from the demodulator 104 (step S301). If the reception control information is ringing information, the microprocessor 110 sets the signal pass-band to a pass-band of from 100 Hz to 20 kHz (step S302). At this step, the microprocessor 110 chooses the characteristic of the lowpass filter 130b as the frequency characteristic of the digital lowpass filter 130 in accordance with a selection signal 160. At the same time, the microprocessor 110 renders the preamplifier 133b and the push-pull circuit 133d of the speaker amplifier 133 in an active state in accordance with a selection signal 161. Furthermore, at the same time, the microprocessor 110 switches the analog switches 134a and 134b of the highpass filter circuit 134 to the respective contacts 134a1 and 134b1 in accordance with a selection signal 162, and thereby sets the output form (circuit configuration) of the speaker amplifier 133 to the BTL output form and sets the signal pass-band to a pass-band of from 100 Hz to 20 kHz.

Then, the microprocessor 110 reproduces a ringer melody and thereby notifies the user of the cellular telephone apparatus 100 about arrival of a call (step S303). At this step, the microprocessor 110 sends ringer melody data (stored in the memory (not shown)) to the ringer tone source 123 and instructs the ringer tone source 123 to generate a ringer melody. The ringer melody data that is output from the ringer tone source 123 is high-frequency-limited at 20 kHz by the digital lowpass filter 130, converted into an analog signal by the D/A converter 131, subjected to volume setting to a prescribed value by the volume setting device 132, current-amplified by the speaker amplifier 133, and subjected to cutting of a low-frequency component of 100 Hz or less by the highpass filter circuit 134. The thus-processed ringer melody data reaches the speaker 135, which reproduces a ringer melody.

Notified about arrival of a ringing call by ringer tone output of the speaker 135, the user of the cellular telephone apparatus 100 depresses a call start key among the key switches (not shown) which are connected to the microprocessor 110 (step S304).

The microprocessor 110 detects the depression state of the call start key, and instructs the ringer tone source 123 to stop the generation of the ringer melody. At the same time, the microprocessor 110 sends, to the modulator 105, transmission control information indicating reception of the ringing call and informs a base station about the reception of the ringing call via the transmitting circuit 106, the duplexer 102, and the antenna 101 (step S305).

The base station receives the transmission control information indicating reception of the ringing call (step S306) and transmits, to the cellular telephone apparatus 100, control information for rendering a speech channel open (step S307).

The cellular telephone apparatus 100 receives the control information for rendering a speech channel open (step S308). At this step, the control information for rendering a speech channel open is communicated to the microprocessor 110 via the antenna 101, the duplexer 102, the receiving circuit 103, and the demodulator 104.

Receiving the control information for rendering a speech channel open, the microprocessor 110 sets the signal pass-band to a pass-band of from 300 Hz to 3 kHz (step S309). At this step, the microprocessor 110 sends, to the decoder 121 and the encoder 122, instructions for rendering them in an active state. At the same time, the microprocessor 110 chooses the characteristic of the lowpass filter 130a as the frequency characteristic of the digital lowpass filter 130 in accordance with a selection signal 160. At the same time, the microprocessor 110 renders the preamplifier 133b and the push-pull circuit 133d of the speaker amplifier 133 in a halt state in accordance with a selection signal 161. Furthermore, at the same time, the microprocessor 110 switches the analog switches 134a and 134b of the highpass filter circuit 134 to the respective contacts 134a2 and 134b2 in accordance with a selection signal 162, and thereby sets the output form (circuit configuration) of the speaker amplifier 133 to the single output and sets the signal pass-band to a pass-band of from 300 kHz to 3 kHz.

Then, the microprocessor 110 sends speech channel opening completion information to the modulator 105 as transmission control information and thereby informs the base station about completion of opening of a speech channel via the transmitting circuit 106, the duplexer 102, and the antenna 101 (step S310).

The base station receives the transmission control information indicating the completion of opening of a speech channel (step S311) and transmits speech data to the cellular telephone apparatus 100 (step S312).

The cellular telephone apparatus 100 receives the speech data (reception speech data) (step S313) and reproduces the reception speech data (step S314). At this step, the reception speech data is supplied to the decoder 121 via the antenna 101, the duplexer 102, the receiving circuit 103, and the demodulator 104. The decoder 121 decodes the thus-supplied reception speech data into a reception speech signal and sends the latter to the digital lowpass filter 130. The reception signal is high-frequency-limited at 3 kHz by the digital lowpass filter 130, converted into an analog signal by the D/A converter 131, subjected to volume setting to a prescribed value by the volume setting device 132, current-amplified by the speaker amplifier 133, and subjected to cutting of a low-frequency component of 300 Hz or less by the highpass filter circuit 134. The thus-processed reception signal reaches the speaker 135, which reproduces a voice.

The dynamic range of a case that the output form of the speaker amplifier 133 is set to the single output is 6 dB narrower than that of a case that it is set to the BTL output. However, since the difference between the maximum volume of a ringer tone and that of a speech sound is more than or equal to 10 dB, a dynamic range that is wide enough to reproduce a speech sound properly can be secured even if the output form of the speaker amplifier 133 is set to the single output.

In the above-described cellular telephone apparatus according to the first embodiment of the invention, the single sound-producing body is used as both of the sound-producing body for reproducing a speech sound and the sound-producing body for reproducing a ringer tone, the drive circuit for driving the sound-producing body is the single drive circuit, and the drive form of the drive circuit is switched between the BTL drive output and the single drive output depending on which of a speech sound and a ringer tone is to be reproduced. As a result, a ringer tone can be reproduced at a large volume by driving the dynamic speaker having equivalent impedance of 8Ω in the BTL output form.

On the other hand, a speech sound can be reproduced at a sufficiently large volume by switching the drive form to the single output. Since one of the BTL outputs of the drive circuit is disabled, the current consumption of the drive circuit can be reduced and hence the usable time for calls of the cellular telephone apparatus can be elongated.

Since the signal pass-band characteristic of the drive circuit for driving the sound-producing body or the preprocessing circuit of the drive circuit is switched depending on which of a speech sound and a ringer tone is to be reproduced, the high-frequency signal passage characteristic can be switched depending on which of a speech sound and a ringer tone is to be reproduced. As a result, a passage characteristic having an upper limit of several kilohertz can be set during a call (conversation) and a passage characteristic having an upper limit of a little more than 10 kHz can be set during reproduction of a ringer tone. This provides an advantage that a necessary reproduction frequency characteristic can be satisfied for each of the reproduction of a speech sound and the reproduction of a ringer tone, though the common drive circuit and sound-producing body are employed.

Furthermore, since the signal pass-band characteristic of the post-processing circuit of the drive circuit for driving the sound-producing body is switched depending on which of a speech sound and a ringer tone is to be reproduced, the low-frequency signal passage characteristic can be switched depending on which of a speech sound and a ringer tone is to be reproduced. As a result, a passage characteristic having a lower limit of hundreds of hertz can be set during a call (conversation) and a passage characteristic having a lower limit of about 100 kHz can be set during reproduction of a ringer tone. This provides an advantage that a necessary reproduction frequency characteristic can be satisfied for each of the reproduction of a speech sound and the reproduction of a ringer tone, though the common drive circuit and sound-producing body are employed.

In this embodiment, the high-frequency pass-band is switched by means of the digital lowpass filter 130. Alternatively, the same function can be implemented by incorporating an active lowpass filter in the speaker amplifier 133 and switching the cutoff frequency by switching the filter constants of the active lowpass filter.

Furthermore, although this embodiment employs a class AB amplifier as the speaker amplifier 133, the same advantages can be obtained even if a class D amplifier is employed.

### Second Embodiment

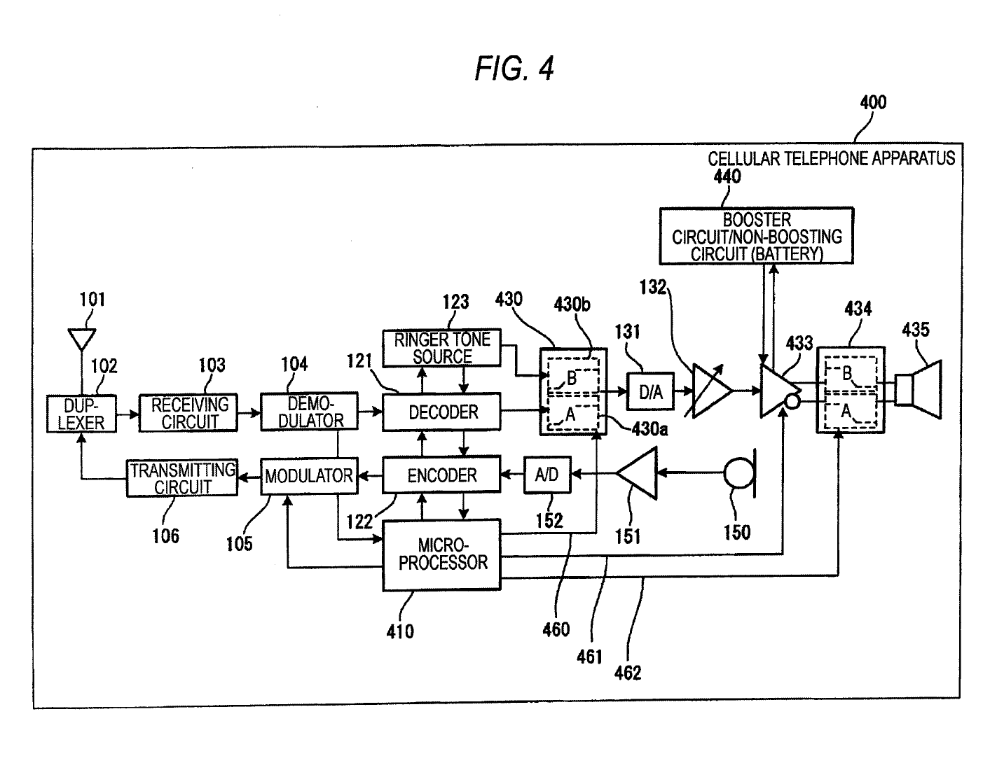

FIG. 4 is a block diagram showing the configuration of a cellular telephone apparatus according to a second embodiment of the invention. The cellular telephone apparatus according to the second embodiment is different in configuration from the cellular telephone apparatus according to the first embodiment shown in FIG. 1 in that the microprocessor 110 is replaced by a microprocessor 410 whose functions are somewhat different from the functions of the former, the digital lowpass filter 130 is replaced by a digital highpass filter 430, the speaker amplifier 133 is replaced by a speaker amplifier 433, the highpass filter 134 is replaced by a lowpass filter 434, the speaker 135 is replaced by a speaker 435, and the amplifier power source 140 is replaced by a booster circuit/non-boosting circuit 440. Components having the same components in the cellular telephone apparatus 100 according to the first embodiment shown in FIG. 1 are given the same reference symbols as the latter and will not be described below.

The microprocessor 410 controls the individual sections of the cellular telephone apparatus 400. The digital highpass filter 430 performs low-frequency band limitation processing on a ringer tone signal coming from the ringer tone source 123 or a reception speech signal coming from the decoder 121, and is composed of two digital highpass filters having different frequency passage characteristics. The circuit configuration is such that one of the two digital highpass filters having the different frequency passage characteristics is chosen in accordance with a selection signal 460 supplied from the microprocessor 410. Of the two digital highpass filters having the different frequency passage characteristics, one highpass filter 430a is a highpass filter whose cutoff frequency is 300 Hz and the other highpass filter 430b is a highpass filter whose cutoff frequency is 100 Hz.

The speaker amplifier 433 amplifies a ringer tone signal or a reception speech signal and drives the speaker 435, and is a BTL-output, class AB amplifier. The circuit configuration is such that the bias voltage of the transistors constituting output-stage push-pull circuits can be switched in accordance with a selection signal 461 supplied from the microprocessor 110.

The lowpass filter 434 performs high-frequency bandwidth limitation processing on a ringer tone signal or a reception speech that is output from the speaker amplifier 433, and is composed of two lowpass filters having different frequency passage characteristics. The circuit configuration is such that one of the two lowpass filters having the different frequency passage characteristics is chosen in accordance with a selection signal 462 supplied from the microprocessor 410. Of the two lowpass filters having the different frequency passage characteristics, one lowpass filter 434a is a lowpass filter whose cutoff frequency is 20 kHz and the other lowpass filter 130b is a lowpass filter whose cutoff frequency is 3 kHz.

The speaker 435 reproduces a ringer tone or a reception speech sound and, in this embodiment, is a ceramic speaker.

The booster circuit/non-boosting circuit 440 is a power circuit for the speaker amplifier. The circuit configuration is such that one of the output of a 9-V booster circuit and a battery output voltage is output in accordance with the selection signal 461 supplied from the microprocessor 410.

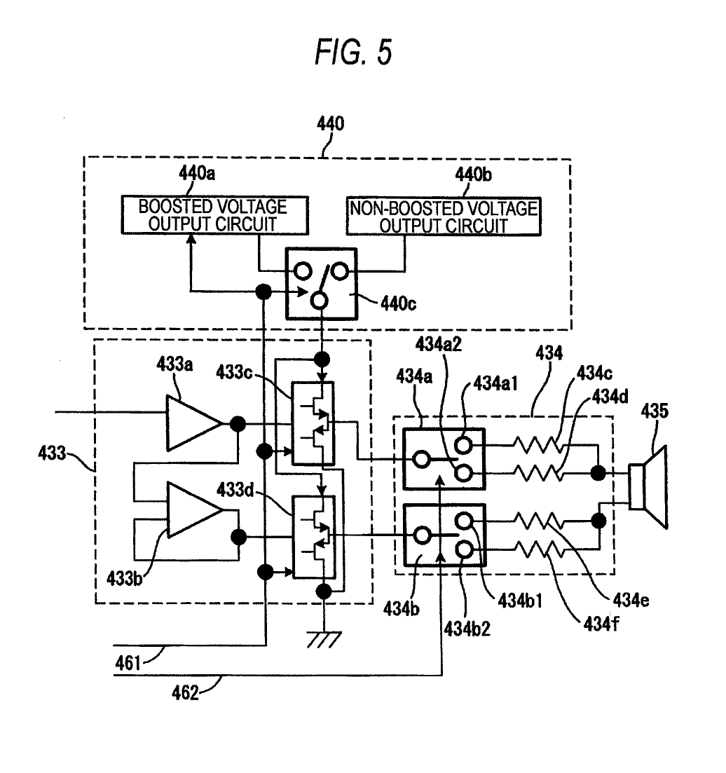

FIG. 5 shows detailed circuit configurations of the speaker amplifier 433, the lowpass filter circuit 434, and the booster circuit/non-boosting circuit 440.

The speaker amplifier 433 has a preamplifier 433a, a preamplifier 433b which phase-inverts an output of the preamplifier 433a, a push-pull circuit 433c which current-amplifies the output of the preamplifier 433a and performs class AB operation, and a push-pull circuit 433d which current-amplifies an output of the preamplifier 133b and performs class AB operation.

The circuit configuration is such that the bias voltage of the output transistors constituting each of the push-pull circuits 433c and 433d can be switched between a bias voltage-1 and a bias voltage-2 in accordance with a selection signal 461.

The bias voltage 1 is so high a voltage that cross-over distortion does not occur when the speaker 435 as the load of the speaker amplifier 433 is driven at a drive frequency of 3 kHz. The bias voltage-2 is so high a voltage that cross-over distortion does not occur when the speaker 435 as the load of the speaker amplifier 433 is driven at a drive frequency of 20 kHz. Since the speaker 435 is a ceramic speaker which is a capacitive load, its impedance is larger at 20 kHz than at 3 kHz. Therefore, the bias voltage-2 is higher than the bias voltage 1. The current consumed in each push-pull circuit itself is smaller when the bias voltage 1 is chosen than when the bias voltage-2 is chosen.

The lowpass filter circuit 434 is composed of analog switches 434a and 434b and resistors 434c, 434d, 434e, and 434f which constitute an RC filter when combined with the capacitive impedance of the speaker 435. Switching between the contacts of each of the analog switches 434a and 434b can be made in accordance with a selection signal 462. The resistance values of the resistors 434c and 434e are set so that the cutoff frequency of the lowpass filter becomes about 20 kHz in a state that the analog switch 434a is switched to a contact 434a1 and the analog switch 434b is switched to a contact 434b1. On the other hand, the resistance values of the resistors 434d and 434f are set so that the cutoff frequency of the lowpass filter becomes about 3 kHz in a state that the analog switch 434a is switched to a contact 434a2 and the analog switch 434b is switched to a contact 434b2. The analog switches 434a and 434b have small on-resistance values and hence such things as voltage drops across them are negligible.

The booster circuit/non-boosting circuit 440 has a boosted voltage output circuit 440a which boosts an input battery voltage and outputs a resulting voltage of 9 V, a non-boosted voltage output circuit 440b which outputs the battery voltage, and a switch 440c which switches between the output of the boosted voltage output circuit 440a and the output of the non-boosted voltage output circuit 440b and outputs a resulting voltage. The circuit configuration is such that when the switch 440c is switched so as to choose the output of the non-boosted voltage output circuit 440b, the boosted voltage output circuit 440a suspends its boosting operation.

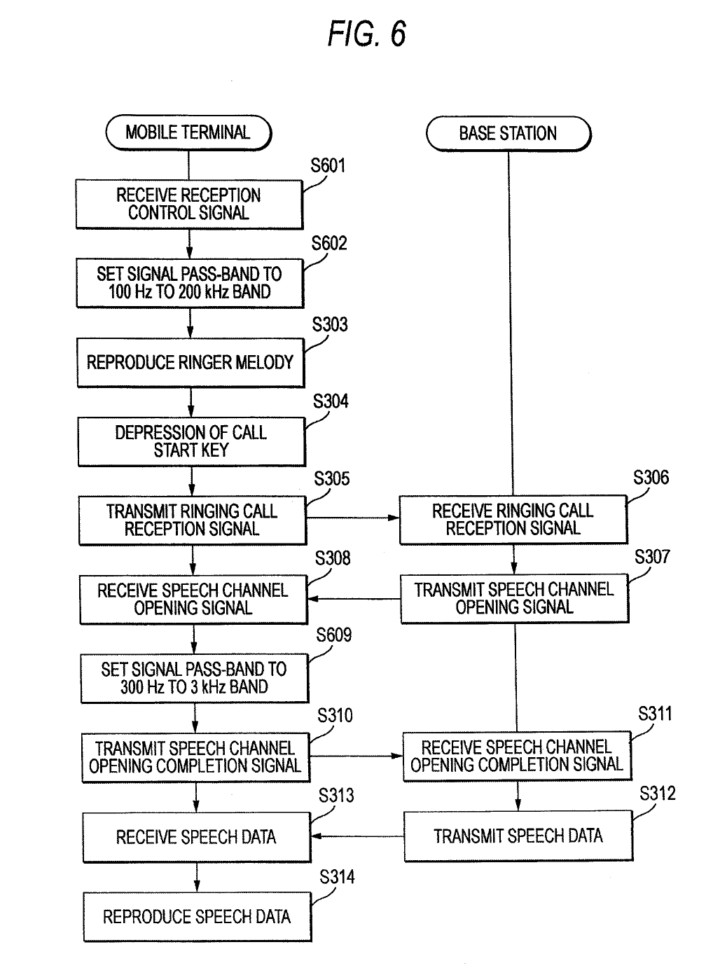

The operation of the above-configured cellular telephone apparatus 400 will be described below with reference to FIG. 6.

First, the microprocessor 410 receives reception control information from the demodulator 104 (step S601). If the reception control information is ringing information, the microprocessor 410 sets the signal pass-band to a pass-band of from 100 Hz to 20 kHz (step S602). At this step, the microprocessor 410 chooses the characteristic of the highpass filter 430b as the frequency characteristic of the digital highpass filter 430 in accordance with a selection signal 460. At the same time, the microprocessor 410 sets, to the above-mentioned bias voltage-2, the bias voltage of the transistors constituting each of the push-pull circuits 433c and 433d of the speaker amplifier 433 and chooses the output of the boosted-voltage output circuit 440a as the output of the switch 440c of the power circuit 440 in accordance with a selection signal 461. Furthermore, at the same time, the microprocessor 410 switches the analog switches 434a and 434b of the lowpass filter circuit 434 to the respective contacts 434a1 and 434b1 in accordance with a selection signal 462. With these operations, the microprocessor 410 gives the speaker amplifier 433 an ability to drive the speaker 435 at 20 kHz, supplies a power source voltage of 9 V to the speaker amplifier 433, and sets the signal pass-band to a pass-band of from 100 Hz to 20 kHz.

Operations that are performed after setting the signal pass-band to the pass-band of from 100 Hz to 20 kHz, that is, steps S303-S308, are the same as in the first embodiment (see FIG. 3) and hence will not be described.

Receiving the reception control information for rendering a speech channel open at step S308, the microprocessor 410 sets the signal pass-band to a pass-band of from 300 Hz to 3 kHz (step S609). At this step, the microprocessor 410 sends, to the decoder 121 and the encoder 122, instructions for rendering them in an active state. At the same time, the microprocessor 410 chooses the characteristic of the highpass filter 430a as the frequency characteristic of the digital highpass filter 430 in accordance with a selection signal 460. At the same time, the microprocessor 410 sets, to the above-mentioned bias voltage-1, the bias voltage of the transistors constituting each of the push-pull circuits 433c and 433d of the speaker amplifier 433 and chooses the output of the non-boosted-voltage output circuit 440b as the output of the switch 440c of the power circuit 440 in accordance with a selection signal 461. Furthermore, at the same time, the microprocessor 410 switches the analog switches 434a and 434b of the lowpass filter circuit 434 to the respective contacts 434a2 and 434b2 in accordance with a selection signal 462. With these operations, the microprocessor 410 gives the speaker amplifier 433 an ability to drive the speaker 335 at 3 kHz, reduces the current consumed by the speaker amplifier 433 itself, supplies a power source voltage of the battery voltage level to the speaker amplifier 433, making a setting for suspending the boosting operation of the boosted voltage output circuit 440a, and sets the signal pass-band to a pass-band of from 100 Hz to 3 kHz.

Operations that are performed after setting the signal pass-band to the pass-band of from 100 Hz to 3 kHz, that is, steps S310-S314 are the same as in the first embodiment (see FIG. 3) and hence will not be described.

The dynamic range of a case that the power source voltage of the speaker amplifier 433 is set at 3.2 V which is the minimum voltage (battery voltage) is about 9 dB narrower than that of a case that it is set at 9 V. However, since the difference between the maximum volume of a ringer tone and that of a speech sound is more than or equal to 10 dB, a dynamic range that is wide enough to reproduce a speech sound properly can be secured even if the power source voltage of the speaker amplifier 433 is set at 3.2 V which is the minimum voltage (battery voltage).

In the above-described cellular telephone apparatus according to the second embodiment of the invention, the single sound-producing body is used as both of the sound-producing body for reproducing a speech sound and the sound-producing body for reproducing a ringer tone, the drive circuit for driving the sound-producing body is the single drive circuit, a piezoelectric device is used in the sound-producing body, and the output state of the power circuit for the drive circuit for driving the sound-producing body is switched between the boosted voltage output and the non-boosted voltage output depending on which of a speech sound and a ringer tone is to be reproduced. As a result, the booster circuit which is provided in the power circuit for the drive circuit is activated during reproduction of a ringer tone in which a large volume is required, whereby a voltage that is a little more than 10 V can be applied to the drive circuit. During reproduction of a speech sound, the booster circuit which is provided in the power circuit for the drive circuit is disabled and a voltage that is high enough to reproduce a speech sound and is provided in the power circuit is output. As a result, during reproduction of a speech sound, the current consumed in the power circuit for the drive circuit can be reduced and hence the usable time for calls of the cellular telephone apparatus can be elongated.

In this embodiment, the low-frequency pass-band is switched by means of the digital highpass filter 430. Alternatively, the same function can be implemented by incorporating an active highpass filter in the speaker amplifier 433 and switching the cutoff frequency by switching the filter constants of the active highpass filter.

Furthermore, although this embodiment employs a class AB amplifier as the speaker amplifier 433, the same advantages can be obtained even if a class D amplifier is employed.

The invention has been described above in detail by using the particular embodiments. However, it is apparent to those skilled in the art that various changes and modifications are possible without departing from the spirit and scope of the invention.

This application is based on Japanese Patent Application No. 2004-235208 filed on Aug. 12, 2004, the disclosure of which is incorporated by reference herein.

### INDUSTRIAL APPLICABILITY

The invention provides the advantages that a single sound-producing body can be used as both of a receiver for reproducing a speech sound and a speaker for reproducing a ringer tone and that a necessary reproduction frequency characteristic can be secured for each of the reproduction of a speech sound and the reproduction of a ringer tone. As such, the invention is useful when applied to cellular telephone apparatuses etc.

1. A cellular telephone apparatus in which a single sound-producing body is used as both of a sound-producing body for reproducing a speech sound and a sound-producing body for reproducing a ringer tone and a drive circuit for driving the sound-producing body is a single drive circuit, comprising:
a drive circuit switching unit which switches a drive form of the drive circuit; and
a control unit which controls the switching of the drive form of the drive circuit.

2. The cellular telephone apparatus according to claim 1, wherein the drive form which is switched by the drive circuit switching unit includes BTL drive output and single drive output.

3. The cellular telephone apparatus according to claim 1, wherein the control unit causes switching of the drive form of the drive circuit so that BTL drive output is selected as the drive form of the drive circuit during reproduction of a ringer tone and single drive output is selected as the drive form of the drive circuit during reproduction of a speech sound.

4. A cellular telephone apparatus in which a single sound-producing body is used as both of a sound-producing body for reproducing a speech sound and a sound-producing body for reproducing a ringer tone and a drive circuit for driving the sound-producing body is a single drive circuit, comprising:
a power circuit output state switching unit which switches an output state of a power circuit for the drive circuit for driving the sound-producing body between boosted voltage output and non-boosted voltage output, the sound-producing body using a piezoelectric device; and
a control unit which controls the switching of the output state of the power circuit for the drive circuit for driving the sound-producing body.

5. The cellular telephone apparatus according to claim 4, wherein the control unit performs a control so that the power circuit output state is made the boosted voltage output during reproduction of a ringer tone and the power circuit output state is made the non-boosted voltage output during reproduction of a speech sound.

6. The cellular telephone apparatus according to claim 4, further comprising a bias voltage switching unit which switches a bias voltage of an output-stage transistor of the drive circuit for driving the sound-producing body depending on which of a ringer tone and a speech sound is to be reproduced.

7. The cellular telephone apparatus according to any one of claims 1, wherein the control unit switches a signal pass-band characteristic of the drive circuit for driving the sound-producing body or a preprocessing circuit of the drive circuit depending on which of the ringer tone and the speech sound is to be reproduced.

8. The cellular telephone apparatus according to claim 1, wherein the control unit switches a signal pass-band characteristic of a post-processing circuit of the drive circuit for driving the sound-producing body depending on which of the ringer tone and the speech sound is to be reproduced.

9. The cellular telephone apparatus according to claim 4, wherein the control unit switches a signal pass-band characteristic of the drive circuit for driving the sound-producing body or a preprocessing circuit of the drive circuit depending on which of the ringer tone and the speech sound is to be reproduced.

10. The cellular telephone apparatus according to claim 4, wherein the control unit switches a signal pass-band characteristic of a post-processing circuit of the drive circuit for driving the sound-producing body depending on which of the ringer tone and the speech sound is to be reproduced.
